(19) United States
(12) Patent Application Publication
(10) Pub. No.: US 2007/0066247 A1
(43) Pub. Date: Mar. 22, 2007

(54) Hand-held make-up mirror

(76) Inventor: Kiersten Mooney, Naples, FL (US)

Correspondence Address: Kiersten Mooney, 8477 Bay Colony #1002, Naples, FL, 34108, US

(21) Appl. No.: 11/232,363

(22) Filed: Sep. 22, 2005

(51) Int. Cl. H04B 1/38

(52) U.S. Cl. 455/90.3

(57) ABSTRACT

A make-up mirror is attached to a basic structure of a cell phone. The mirror is a one-way see-through mirror and attached over the data display screen of the cell phone. When the cell phone is turned ‘on’, the one-way mirror allows the displayed data to appear there through. When the cell phone is not in use, that is, turned ‘off’, the mirror acts as a normal mirror and can be used for whatever purpose desired. The mirror can be installed in a permanent manner by the manufacturer or it can be removably attached over the display screen as a retrofit in existing cell phones.

### FIELD OF THE INVENTION

This invention pertains to a hand-held mirror that can be carried on a person by way of a pocket, by way of a hand bag or by way of a casing on the belt of a wearer.

### BACKGROUND OF THE INVENTION

There are many hand-held mirrors known to be carried on a person that can be held in the hand of a person using the same. Such hand-held mirrors may be obtained in a protective casing and is useful when retracted from the casing or folded from the casing. Most make-up mirrors are used in combination with a make-up kit as an addition thereto. The cover is simply opened and the mirror in the cover is readily available.

### BRIEF DESCRIPTION OF THE INVENTION

The inventive make-up mirror serves a dual function because it is used in combination with a hand-held cell phone. A cell phone, when not in use, normally displays a gray colored data screen and, when in use, normally displays the data dialed into the phone mostly in an LCD format but sometimes in an LED format. The inventive concept attaches a one-way see-through mirror over or onto the screen whereby any data displayed can be seen through the one-way mirror. However, when the cell phone is turned off, the one-way mirror converts to a mirror that can be used as a dual function of the cell phone as a make-up mirror or other use because the mirror will display the reflection of a person looking into the mirror and the mirror will remain in this state unless the cell phone is turned on again to thereby display and activate the needed data which will shine through the mirror.

### BRIEF DESCRIPTION OF THE DRAWINGS

FIG. 1 shows a basic cell phone with data displayed on a screen through a one-way see-through mirror.

FIG. 2 illustrates the basic cell phone of FIG. 1 with the mirror removed therefrom in an exploded view;

FIG. 3 shows the normal use of a cell phone;

FIG. 4 shows the cell phone with a one-way mirror attached thereon and with the cell phone turned off;

FIGS. 5 and 6 illustrate means for attaching a one-way mirror to the screen of a cell phone;

FIG. 7 shows a cell phone having a display on the outer cover of a cell phone with a one-way mirror attached thereto.

### DETAILED DESCRIPTION OF THE INVENTION

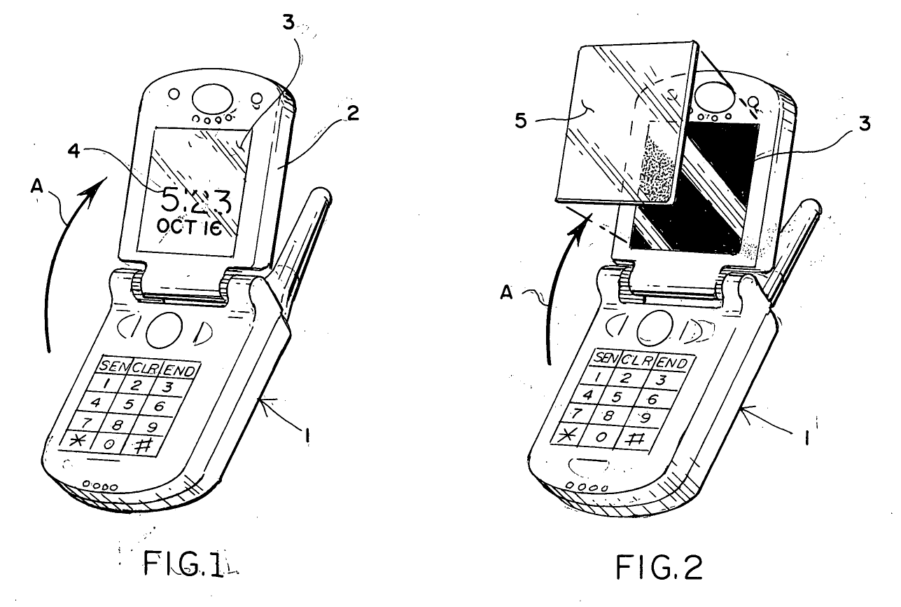

FIG. 1 illustrates a regular cell phone 1 having a pivotal cover 2 thereon. There is shown a regular screen 3 displaying the desired data 4 because the cell phone is in an ‘on’ mode. The cover 2 can be moved to an open position as is shown by the arrow A.

FIG. 2 shows the cell phone of FIG. 1 in an ‘off’ mode because the screen 3 appears in a darkened or gray appearance. The mirror 5 is shown in an exploded view which will be fastened over the darkened screen 3. At this point, the mirror 5 acts like a mirror because no lighted data appears through the one-way mirror.

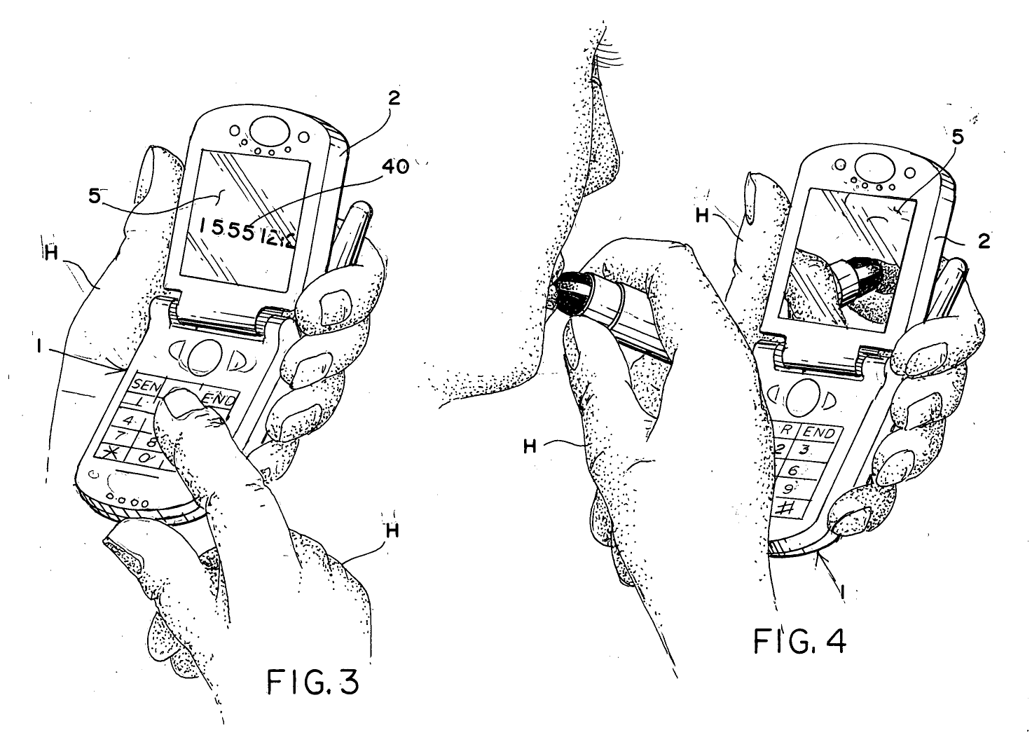

FIG. 3 illustrates the cell phone turned ‘on’ because the data 40 shines through the mirror 6 and the cell phone can be used like any other regular cell phone.

FIG. 4 shows the cell phone of FIG. 3 in a turned ‘off’ mode whereby the mirror 5 starts to act like mirror and can be used for any purpose desired like a hand-held make-up mirror as is demonstrated by the hand H.

The mirror 5 can be installed permanently over the screen 5 when the phone is manufactured. On the other hand, the mirror can be installed on any existing cell phone as a retrofit. It is merely up to the dealer to stock a certain number of certain sizes to match the sizes of the screens of existing phones.

FIG. 5 shows such a retrofitted mirror 5 in a downward view having an elastic band attached thereto. It is merely up to the user to slip the elastic band over the phone casing whereby the mirror 5 is held in place. This mirror can be removed at any time at the will of the user.

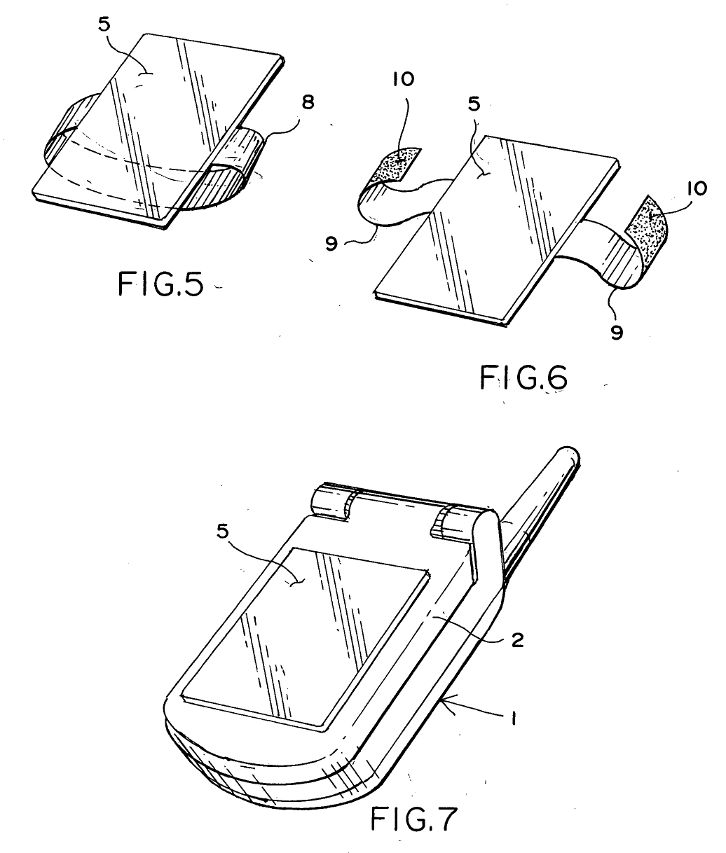

FIG. 6 shows the same arrangement of a removable mirror of FIG. 5 but the attachment to the casing over the screen 3 is obtained by narrow adhesive strips 9 at each edge of the mirror 5. It is merely up to the user to place the mirror 5 over the existing screen 3 of the phone and attach the two adhesive edges to the casing of the phone.

A repeated use in this case may be limited unlike the use of an elastic band 8 as shown in FIG. 5 FIG. 7 shows the same principle of attaching a one-way see-through mirror 5 over a cell phone 1. In this example, the existing screen appears on the outside of the cover 2 in addition to a screen under the cover as was shown in previous Figs. There are also known cell phone structures where there is no pivotal cover included. These phones have just a casing with a screen included and the key board for entering the data is attached on the same face of the cell phone. Obviously, such arrangement lends itself well for an attachment of a permanent one-way see-through mirror 5 or as a retrofit as was shown in FIGS. 5 and 6.

What I claim is:

1. a hand-held make-up mirror, attached to a structure of a cell phone, said mirror is a one-way see-through mirror, said make-up mirror is attached over an existing data exhibiting screen of said cell phone, said mirror allowing said data to appear through said mirror when said cell phone is an ‘on’ mode and acting as a mirror when said cell phone is in an ‘off’ mode.

2. The make-up mirror of claim 1, wherein said screen is located under a cover of said cell phone.

3. The make-up mirror of claim 1, wherein said screen is located on an outside of the casing of said cell phone.

4. The make-up mirror of claim 1, wherein said mirror is a permanent attachment.

5. The make-up mirror of claim 1, wherein said mirror is removably attached to the casing of said cell phone as a retrofit.

6. The make-up mirror of claim 5, wherein said mirror is attached to said cell phone and over said screen by way of an elastic band surrounding the casing of said cell phone.

7. The make-up mirror of claim 5, wherein said mirror is attached to said casing and over said screen by way of adhesive strips at edges of said mirror.
